(19) United States
(12) Patent Application Publication
(10) Pub. No.: US 2008/0171234 A1
(43) Pub. Date: Jul. 17, 2008

(54) Recording medium and manufacturing method therefor

(75) Inventor: Takahiro Imamura, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/002,976

(22) Filed: Dec. 19, 2007

(30) Foreign Application Priority Data
Jan. 12, 2007 (JP) 2007-004555

(51) Int. Cl. G11B 5/66; G11B 5/84

(52) U.S. Cl. 428/827; 428/141; 427/131

(57) ABSTRACT

According to an aspect of an embodiment, a recording medium comprises: a recording layer having a surface uneven, for recording information; a fixed lubricant layer disposed on the recording layer, the fixed lubricant layer being arranged so as to cover the surface and having a flat surface; and a fluid lubricant layer laminated on the fixed lubricant layer, the fluid lubricant layer having fluidity.

### BACKGROUND OF THE INVENTION

### Technical Field

The present invention relates to recording media and manufacturing methods therefor. More particularly, the invention relates to recording media suitable for use as discrete track media or patterned media and manufacturing methods therefor.

### SUMMARY

According to an aspect of an embodiment, a recording medium comprises: a recording layer having a surface uneven, for recording information; a fixed lubricant layer disposed on the recording layer, the fixed lubricant layer being arranged so as to cover the surface and having a flat surface; and a fluid lubricant layer laminated on the fixed lubricant layer, the fluid lubricant layer having fluidity.

### BRIEF DESCRIPTION OF THE DRAWINGS

FIG. 1 is a partial cross-sectional view of a recording medium according to a first embodiment of the present invention;

FIGS. 2A to 2E are each a cross-sectional view showing a step in a method for manufacturing the recording medium according to the first embodiment of the present invention;

FIG. 3 is a partial cross-sectional view of a recording medium according to a second embodiment of the present invention;

FIGS. 4A to 4E are each a cross-sectional view showing a step in a method for manufacturing the recording medium according to the second embodiment of the present invention;

FIG. 5 is a partial cross-sectional view of a recording medium according to a third embodiment of the present invention;

FIGS. 6A to 6D are each a cross-sectional view showing a step in a method for manufacturing the recording medium according to the third embodiment of the present invention;

FIG. 7 is a partial cross-sectional view of a recording medium according to a fourth embodiment of the present invention;

FIGS. 8A to 8D are each a cross-sectional view showing a step in a method for manufacturing the recording medium according to the fourth embodiment of the present invention;

FIG. 9 is a partial cross-sectional view of a recording medium according to a fifth embodiment of the present invention;

FIGS. 10A to 10F are each a cross-sectional view showing a step in a method for manufacturing the recording medium according to the fifth embodiment of the present invention;

FIG. 11 is a partial cross-sectional view of a recording medium according to a sixth embodiment of the present invention;

FIGS. 12A to 12F are each a cross-sectional view showing a step in a method for manufacturing the recording medium according to the sixth embodiment of the present invention;

FIG. 13 is a partial cross-sectional view of a recording medium according to a seventh embodiment of the present invention;

FIGS. 14A to 14E are each a cross-sectional view showing a step in a method for manufacturing the recording medium according to the seventh embodiment of the present invention;

FIG. 15 is a partial cross-sectional view of a recording medium according to an eighth embodiment of the present invention;

FIGS. 16A to 16E are each a cross-sectional view showing a step in a method for manufacturing the recording medium according to the eighth embodiment of the present invention.

FIG. 17 is a plan view showing a magnetic disk device on which a recording medium according to the present invention is mounted;

FIG. 18 is a partial cross-sectional view of a recording medium according to a first known example; and

FIG. 19 is a partial cross-sectional view of a recording medium according to a second known example.

### DESCRIPTION OF THE PREFERRED EMBODIMENTS

Generally, various types of recording media have been provided. Examples thereof include disk-like magnetic recording media used in an HDD (Hard Disk Drive) or the like. In such magnetic recording media, as the amount of information to be recorded has been increasing, there has been a demand for reduction in size and the recording density has been increasing.

Under these circumstances, discrete track media, in which interference between adjacent tracks is decreased to increase the track density, and patterned media, in which interference between adjacent bits is decreased to increase the track recording density, have been proposed. In such magnetic recording media, even if the spacing between recording tracks is decreased sufficiently, it is possible to reduce magnetic influences (crosstalk) between tracks, and thus the recording density can be increased.

Meanwhile, in recording and reproducing operations performed on such magnetic recording media, a magnetic head is used. Specifically, a disk-like magnetic recording medium is rotated at high speed and the magnetic head flies above the disk due to the resistance (viscosity) of air. At that time, in order to perform high-density recording, the magnetic head and the magnetic recording medium are preferably in close proximity to each other. Accordingly, the flying height of the magnetic head is preferably decreased.

However, in each of discrete track media and patterned media, since a recording layer is separated by grooves or the like, fine stepped portions inevitably exist on the surface thereof. When the flying height of the magnetic head is decreased to the limit thereof with respect to each of discrete track media and patterned media in which stepped portions exist, the magnetic head is likely to come into sliding contact with (abut against) the medium. In such a case, there is a possibility that the recording layer disposed on the surface of the disk may be degraded or damaged due to heat and impact caused by sliding, resulting in errors.

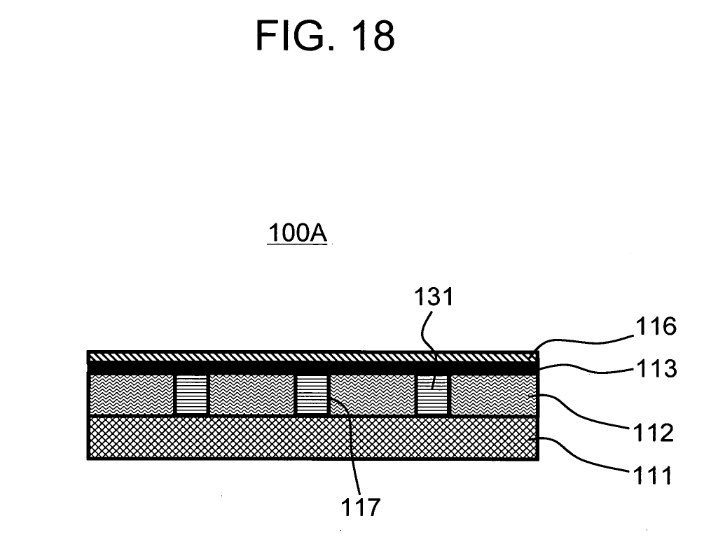

In order to prevent the stepped portions from adversely affecting the movement of the recording head, in known recording media, the stepped portions have been eliminated by a planarization technique. FIG. 18 shows a recording medium formed using such a planarization technique.

A recording medium 100A shown in FIG. 18 is a discrete track medium. In the recording medium 100A, in order to eliminate stepped portions caused by the formation of grooves 117 in a magnetic layer 112, the grooves 117 are filled with rigid, nonmagnetic layers 131 composed of an oxide film, such as alumina or SiO₂, a surface thereof is planarized by a polishing technique, such as chemical mechanical polishing (CMP), a protective film 113 is disposed thereon, and a lubricant 116 is further disposed thereon.

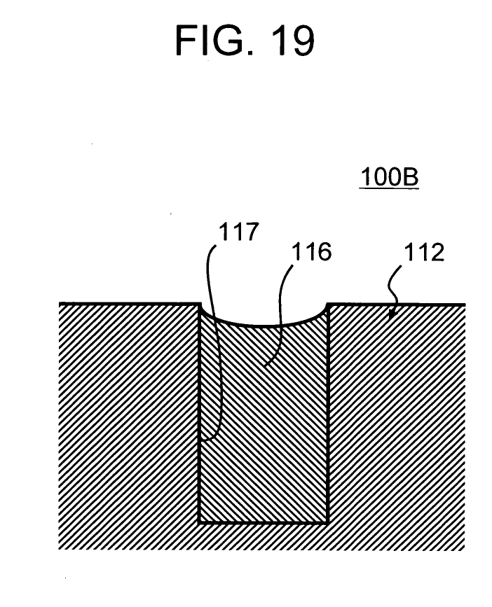

As another known method, that shown in FIG. 19 has been proposed. FIG. 19 shows a recording medium 100B. In the recording medium 100B, a plurality of data tracks are concentrically arranged on a surface of a disk substrate 112 of a recording disk, a medium lubricant 116 having a predetermined volume or more is disposed for each groove 117.

However, although CMP can produce a flat surface with high accuracy, equipment therefor is expensive and the structure of the equipment is complicated. Consequently, by using CMP, the manufacturing process of the recording medium becomes complicated, and the product cost of the recording medium increases, all of which are disadvantageous.

Furthermore, in the technique shown in FIG. 19, the lubricant 116 is not exposed to the uppermost surface, and therefore it is considered to be difficult to obtain sufficient lubricity. Consequently, when a magnetic head comes into sliding contact with the recording medium 100B, there is also a possibility that the recording layer may be degraded or damaged due to heat and impact caused by sliding.

The present invention has been achieved in view of the above-mentioned problems. It is an object of the present invention to provide a recording medium in which the surface can be smoothed without performing a polishing process and sufficient lubricity can be obtained, a method for manufacturing the recording medium, and a recording and reproducing device.

Preferred embodiments of the present invention will be described below with reference to the drawings.

One example of an embodiment of the magnetic recording medium of the present invention is a recording medium of discrete track type or patterned type, which includes a recording layer having irregularities on the surface thereof and a lubricant layer disposed on the recording layer, the lubricant layer including a fixed layer and a fluid layer integrally laminated to each other, the fixed layer being arranged so as to cover the irregularities and subjected to cure treatment, the fluid layer being disposed on the fixed layer and having fluidity.

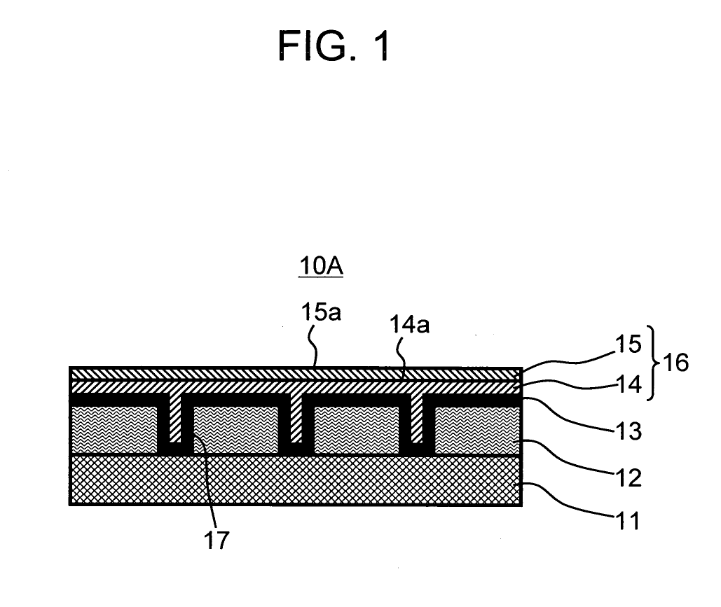

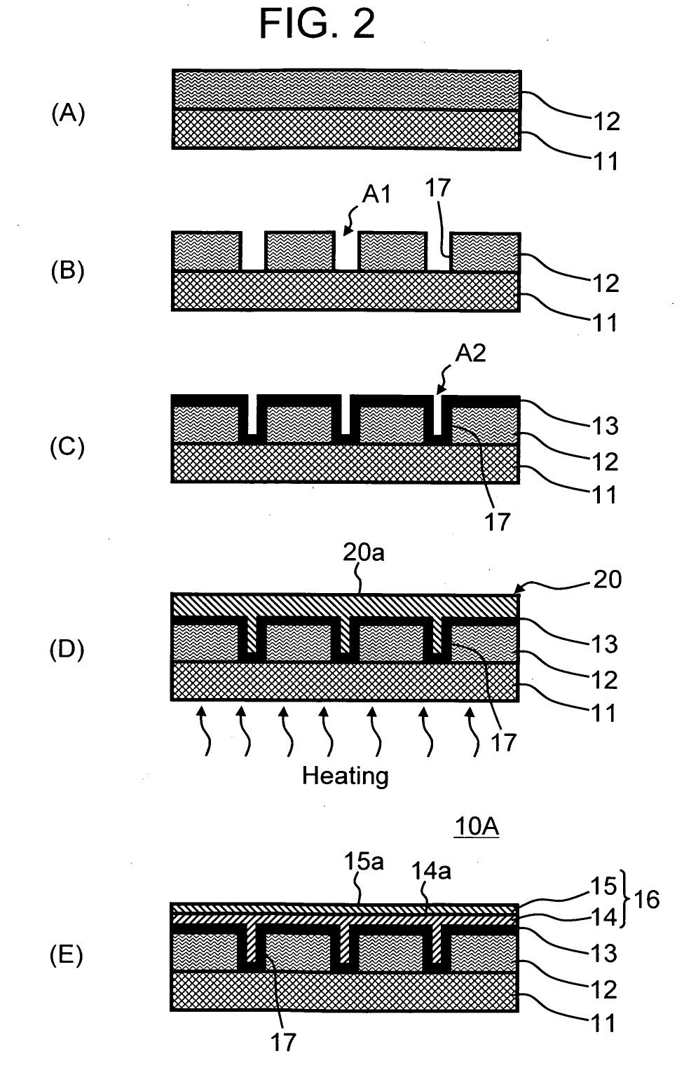

FIG. 1 shows a recording medium 10A according a first embodiment of the present invention, and FIGS. 2A to 2E show a method for manufacturing the recording medium 10A. Note that the recording medium shown as an example in each of FIGS. 1 to 8D is a discrete track medium in which interference between adjacent tracks is decreased to increase the track density. Accordingly, in the description of the embodiments shown in FIGS. 1 to 8D, the recording media are referred to as discrete track media 10A to 10D.

The discrete track medium 10A shown in FIG. 1 is, for example, used as a perpendicular magnetic recording medium.

Broadly speaking, the discrete track medium 10A has a structure in which a soft magnetic layer 11, a magnetic layer (recording layer) 12, a protective film 13, a lubricant layer 16, etc. are disposed on a substrate (not shown in the drawing).

The soft magnetic layer 11 is disposed on a substrate, for example, composed of an insulating material, such as glass or an aluminum alloy. The soft magnetic layer 11 can be composed of a permalloy (Ni—Fe alloy) having high magnetic permeability. The thickness of the soft magnetic layer 11 is, for example, 500 to 1,000 Å.

The magnetic layer 12 is disposed on the soft magnetic layer 11. The magnetic layer 12 can be composed of a Co-based magnetic alloy, such as CoCrP, CoCrTa, CoCrTi, CoCrGe, CoNi, CoNiZr, CoCrW, or CoCrV, or an Fe-based magnetic material, such as γ-Fe₂O₃. The thickness of the magnetic layer 12 is, for example, 200 to 800 Å.

Since the recording medium according to this embodiment is the discrete track medium 10A, grooves 17 are disposed in the magnetic layer 12. The grooves 17 are formed between data track-forming positions. Since the grooves 17 are formed in the magnetic layer 12, stepped portions (irregularities) are formed in the magnetic layer 12.

In the recording medium according to this embodiment, the protective film 13 is disposed on the magnetic layer 12. The protective film 13 is provided in order to prevent corrosion from occurring on the magnetic layer 12. The protective film 13 can be composed of diamond-like carbon (DLC), silicon dioxide, or the like. The thickness of the protective film 13 is, for example, 100 to 200 Å.

Since the protective film 13 protects the magnetic layer 12 as described above, the protective film 13 is formed so as to cover the entire surface of the magnetic layer 12. Since the grooves 17 are disposed in the magnetic layer 12, the protective film 13 is also formed in the grooves 17. However, since the thickness of the protective film 13 is small as described above, the grooves 17 are not completely filled with the protective film 13, and stepped portions (irregularities) resulting from the grooves 17 are also formed in the protective film 13.

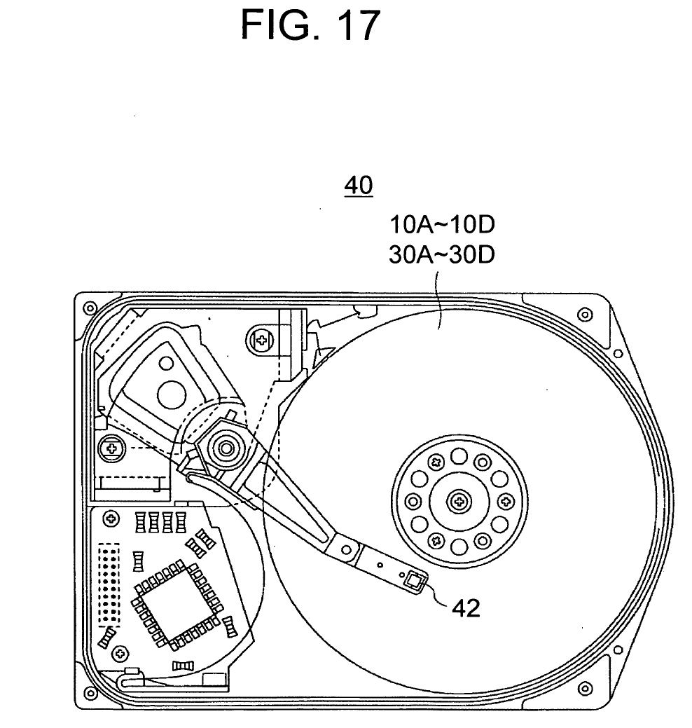

The lubricant layer 16 is provided for the purpose of decreasing the coefficient of friction during sliding with a magnetic head 42 (refer to FIG. 17) and providing water repellency to the surface to prevent corrosion. The lubricant layer 16 can be composed of, for example, perfluoropolyether (PFPE). The PFPE has fluidity at normal temperature, and thus can reduce friction when the magnetic head 42 comes into sliding contact with the discrete track medium 10A.

This embodiment is characterized in that the lubricant layer 16 includes the fixed layer 14 and the fluid layer 15. The fixed layer 14 is located on the magnetic layer 12 side and, as will be described below, is a portion cured (which includes a gelated state) by heat treatment or the like. In contrast, the fluid layer 15 is not subjected to heat treatment or the like, and thus maintains fluidity. In this embodiment, the fixed layer 14 and the fluid layer 15 are continuously and integrally formed.

As will be described in detail below, the fixed layer 14 is disposed, in a state having fluidity before cure treatment, on the protective film 13, and then cure treatment is performed. That is, a lubricant material 20 (refer to FIG. 2D) for forming the fixed layer 14 is arranged inside the stepped portions (irregularities) formed in the protective film 13, and then cure treatment is performed.

Therefore, a surface 14a of the fixed layer 14 and a surface 15a of the fluid layer 15 are smooth surfaces. The smooth surface 14a and the smooth surface 15a can improve the slidability with respect to the magnetic head 42. Furthermore, since the fixed layer 14 and the fluid layer 15 are continuously and integrally formed, bonding strength between the fluid layer 15 and the fixed layer 14 is high. Consequently, even if the discrete track medium 10A is rotated at high speed during magnetic recording and reproducing, it is possible to prevent the fluid layer 15 from separating from the fixed layer 14 and being scattered.

A method for manufacturing the discrete track medium 10A having the structure described above will now be described with reference to FIGS. 2A to 2E. In FIGS. 2A to 2E, the same components are designated by the same reference numerals as those in FIG. 1, and descriptions thereof are omitted.

FIG. 2A shows a state in which a soft magnetic layer 11 and a magnetic layer 12 are formed on a substrate (which is not shown in the drawing). In each of the formation of the soft magnetic layer 11 on the substrate and the formation of the magnetic layer 12 on the soft magnetic layer 11, sputtering can be used.

Subsequently, as shown in FIG. 2B, grooves 17 are formed in the magnetic layer 12. The grooves 17 are formed between predetermined positions at which data tracks are formed, for example, using electron beam lithography or nanoimprinting lithography. By forming the grooves 17 in the magnetic layer 12 in such a manner, stepped portions (irregularities) are formed in the magnetic layer 12 as indicated by arrow A1.

Subsequently to the formation of the grooves 17 in the magnetic layer 12, a protective film 13 is formed over the upper surfaces of the soft magnetic layer 11 and the magnetic layer 12 (film formation step). The protective film 13 can be formed, for example, by sputtering. FIG. 2C shows a state in which the protective film 13 is formed.

As described above, the protective film 13 is composed of a nonmagnetic material, such as DLC or silicon dioxide. Consequently, in order to improve magnetic recording and reproducing characteristics, the thickness of the protective film 13 is preferably as small as possible within the range in which the magnetic layer 12 can be protected. Therefore, even if the protective film 13 is formed, the grooves 17 are not completely filled with the protective film 13, and irregularities resulting from the grooves 17 are also formed in the protective film 13 (indicated by arrow A2 in FIG. 2C)

Subsequently to the formation of the protective film 13, a lubricant material 20 for forming a lubricant layer 16 (material for the lubricant layer 16) is arranged over the protective film 13. The lubricant material 20 is composed of PFPE, which has fluidity at normal temperature. The thickness of the lubricant material 20 arranged over the protective film 13 is set so as to cover the total thickness of a fixed layer 14 and a fluid layer 15.

FIG. 2D shows a state in which the lubricant material 20 is arranged over the protective film 13. Since the lubricant material 20 having fluidity is arranged, the lubricant material 20 is also arranged inside the stepped portions A2 (arrangement step).

At that time, no special arrangement step is required to arrange the lubricant material 20 inside the stepped portions, and by simply disposing the lubricant material 20 over the protective film 13, the lubricant material 20 having fluidity is arranged inside the stepped portions. Furthermore, since the lubricant material 20 has fluidity, even if the lubricant material 20 is arranged over the protective film 13, a surface 20a of the lubricant material 20 is a flat surface without being affected by the shape of the stepped portions in the protective film 13.

After the completion of the arrangement of the lubricant material 20, the lubricant material 20 is subjected to heating treatment from the lower surface side of the soft magnetic layer 11. In the heat treatment, heat is transferred to the lubricant material 20 through the soft magnetic layer 11, the magnetic layer 12, and the protective film 13. That is, the lubricant material 20 composed of PFPE is subjected to heat treatment from the magnetic layer 12 side (curing step).

An end group of the lubricant material 20 bonds selectively to a bonding site on the protective film 13. For instance, when the protective layer 13 consists of DLC, the end group is bonded to a dangling-bond and an amino group located on the surface of DLC. Therefore, the fluidity of the lubricant material 20 decreases gradually from the protective film. The heat treatment promotes the decrease in the fluidity. In the individual embodiment described above, the lubricant material 20 is heated from the magnetic layer 12 side. However, the lubricant material 20 may be heated from any side. For instance, the laminated body having the lubricant material 20 may be heated by an oven, under the condition of 100-150 degree centigrade for 30-120 minutes. Moreover, IR-ray from the side of the lubricant material may be irradiated. In any case, the bond progresses from a part near the protective film.

The heating treatment causes bonding in a predetermined region of the lubricant material 20 close to the magnetic layer 12, and the lubricant material 20 is cured by bonding to form the fixed layer 14. A surface 14a of the fixed layer 14 is a flat surface.

In contrast, in the upper surface side of the lubricant material 20, heat curing does not occur, and as a result, the fluid layer 15 having fluidity is automatically formed on the upper side of the fixed layer 14.

When the laminate having the fixed layer 14 and the fluid layer 15 is immersed in the solvent to dilute such a lubricant material 20 compatible therewith, the fluid layer 15 is removed and the fixed layer 14 is left on the protective film 13. For instance the solvent includes a fluorocarbon-based organic solvents such as Bartorel (brand name), made by the DuPont. The existence of the fixed layer 14 can be confirmed by the difference of the lubricant molecular-derived peak intensity in respective FT-IR spectra before and after the immersing. For instance, the thickness of the fixed layer 14 and the fluid layer 15 is 1 nm respectively.

Fixed layer 14 may be form by irradiating UV-ray instead of the heat treatment. Photoelectrons are emitted from the surface of protective film 13 by irradiating UV-ray. The photoelectrons break the bonds between a carbon atom composed of a main chain and a fluorine atom bonded thereto in the lubricant molecules. Continuously, cross-linking reactions occur between the carbon atoms in the lubricant molecules adjacent. The fluidity of the lubricant molecules forming cross-linking is low. This reaction takes place since it is near the protective film 13 where the photoelectrons are emitted. For instance, the xenon excimer lamp of the wavelength 172 nm is used as an UV-ray source. In other embodiments described later, fixed layer 14 can be formed by irradiating UV-ray instead of the heat treatment. For instance, in the third and seventh embodiment described later, photoelectrons, are emitted from the surface of magnetic layer 12 by irradiating UV-ray. The photoelectrons cause the cross-linking reaction as well as the above-mentioned, and thereby a fixed layer 14 having low fluidity is formed.

In such a manner, the lubricant layer 16 having a structure in which the fixed layer 14 and the fluid layer 15 are laminated is formed. In the lubricant layer 16, the fixed layer 14 is formed because a portion of the arranged lubricant material 20 is heated, and the remaining portion becomes the fluid layer 15. Consequently, the fixed layer 14 and the fluid layer 15 are continuously and integrally formed.

By performing the manufacturing steps described above, a discrete track medium 10A shown in FIG. 2E is obtained. In the method for manufacturing the discrete track medium 10A according to this embodiment, the grooves 17 are formed in the magnetic layer 12 in order to prevent the occurrence of crosstalk due to an increase in density, and even if stepped portions are formed, the surface of the fixed layer 14 (lubricant layer 16) is a flat surface. Consequently, polishing treatment, such as chemical mechanical polishing (CMP), which has been required in the past, is not required, and thus the manufacturing process of the discrete track medium 10A can be simplified and the cost can be reduced.

Furthermore, since the fluid layer 15 having fluidity is present on the fixed layer 14, lubricity can be maintained. Consequently, it is possible to prevent the recording layer from being degraded or damaged due to heat and impact caused by sliding between the magnetic head 42 and the discrete track medium 10A. Furthermore, since the fixed layer 14 is cured, the fixed layer 14 is strongly held in the stepped portions formed in the magnetic layer 12 (protective film 13), and good adhesion is obtained between the fixed layer 14 and the fluid layer 15. Consequently, even if the discrete track medium 10A is rotated at high speed, scattering of the fluid layer 15 can be prevented.

A second embodiment will now be described.

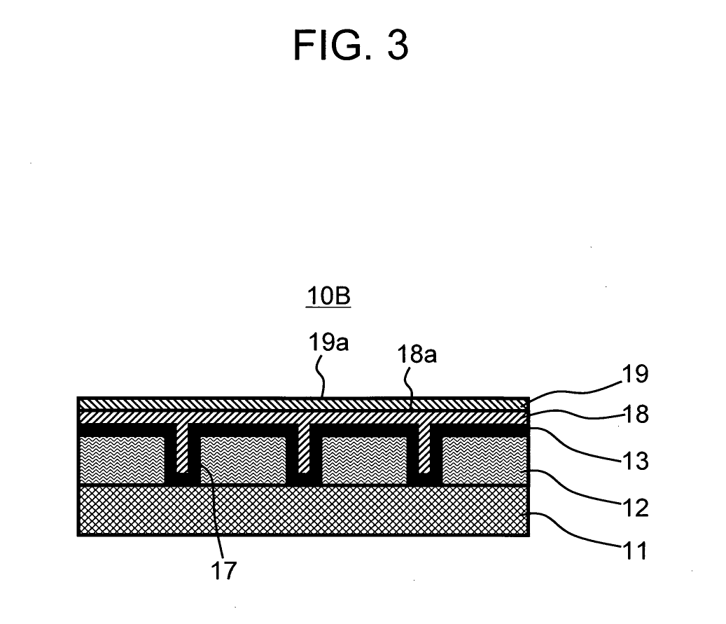

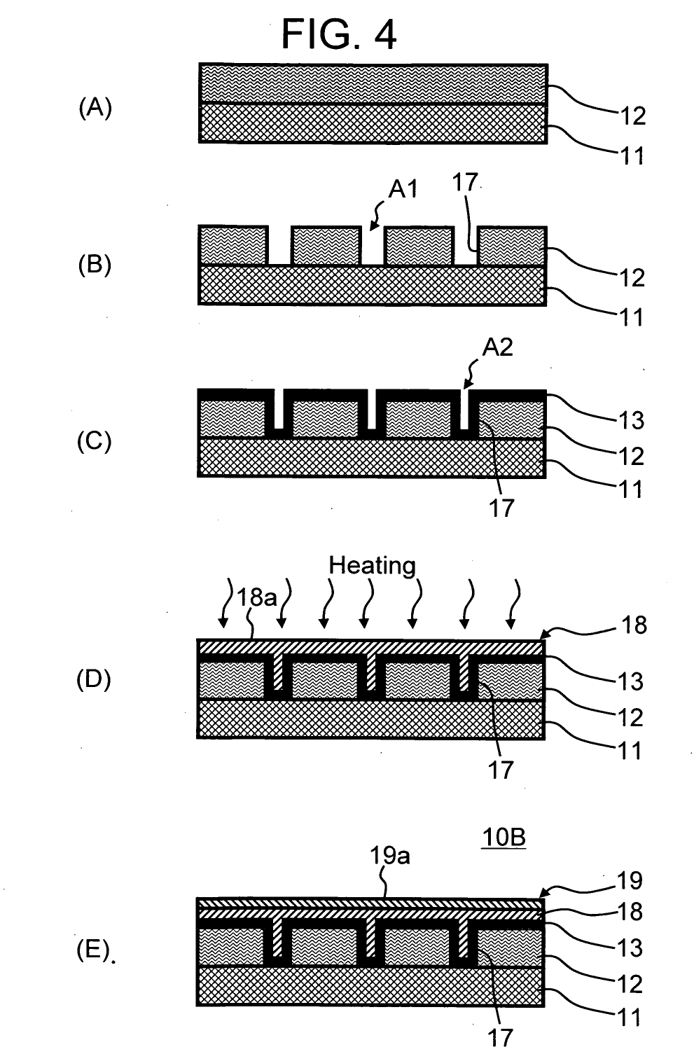

FIG. 3 shows a discrete track medium 10B according to the second embodiment, and FIGS. 4A to 4E show a method for manufacturing the discrete track medium 10B. Note that in FIGS. 3 to 8D, the same components are designated by the same reference numerals as those in FIGS. 1 to 2E, and descriptions thereof are omitted.

In the discrete track medium 10A according to the first embodiment described above, by applying heat to a portion of the lubricant material 20, the lubricant layer 16 has a structure in which the fixed layer 14 and the fluid layer 15 are continuously and integrally formed. In contrast, as shown in FIG. 3, the discrete track medium 10B according to the second embodiment is characterized in that a lubricant layer has a structure which is formed on a protective film 13 and in which a fixed lubricant layer 18 and a fluid lubricant layer 19 each independently formed are laminated.

The discrete track medium 10B is manufactured as shown in FIGS. 4A to 4E. First, as shown in FIG. 4A, a magnetic layer 12 is formed by sputtering or the like on a soft magnetic layer 11 disposed on a substrate. Then, as shown in FIG. 4B, grooves 17 are formed. Subsequently, as shown in FIG. 4C, a protective film 13 is formed by sputtering or the like over the magnetic layer 12 provided with the grooves 17 and the soft magnetic layer 11. The manufacturing steps up to this stage are the same as those shown in FIGS. 2A to 2C.

In the second embodiment, subsequently, a lubricant material 20 (not shown in the drawing) is arranged over the protective film 13 (first arrangement step). Since the lubricant material 20 has fluidity, the lubricant material 20 is also arranged inside stepped portions A2 resulting from the grooves 17 formed in the protective film 13. Furthermore, since the lubricant material 20 has fluidity in a state arranged in the stepped portions A2, the surface of the lubricant material 20 is a flat surface.

Subsequently, the lubricant material 20 is cured by heat treatment from the above. Thus, as shown in FIG. 4D, a fixed lubricant layer 18 is formed on the protective film 13 (curing step). As described above, since a surface 20a of the lubricant material 20 before curing is flat, a surface 18a of the fixed lubricant layer 18 which has been heat-cured is also a flat surface.

After the formation of the fixed lubricant layer 18, a lubricant material 20 is further arranged thereon (second arrangement step). This lubricant material 20 is not subjected to heat cure treatment. Consequently, the lubricant material 20 directly serves as a fluid lubricant layer 19. By performing the manufacturing steps described above, a discrete track medium 10B shown in FIG. 4E is obtained.

In the method for manufacturing the discrete track medium 10B according to the second embodiment, polishing treatment, such as CMP, which has been required in the past, is also not required, and thus the manufacturing process can be simplified and the cost can be reduced. Furthermore, since the fluid lubricant layer 19 having fluidity is present on the fixed lubricant layer 18, lubricity can be maintained. Consequently, it is possible to prevent the recording layer from being degraded or damaged due to heat and impact caused by sliding between the magnetic head 42 and the discrete track medium 10B.

A third embodiment will now be described.

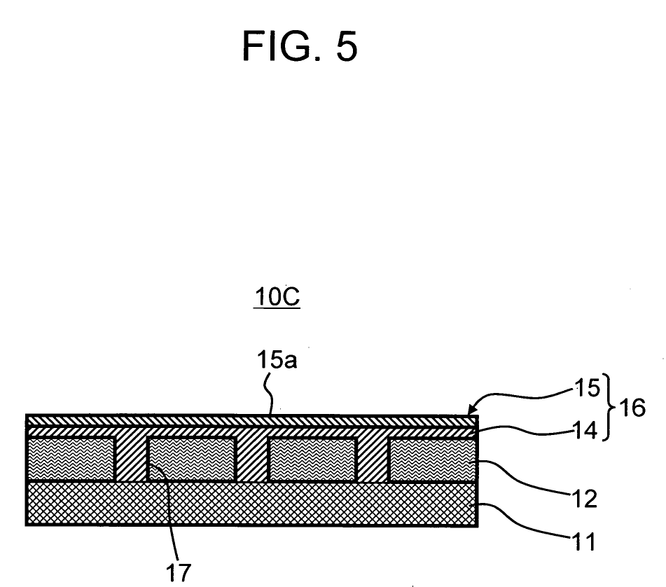

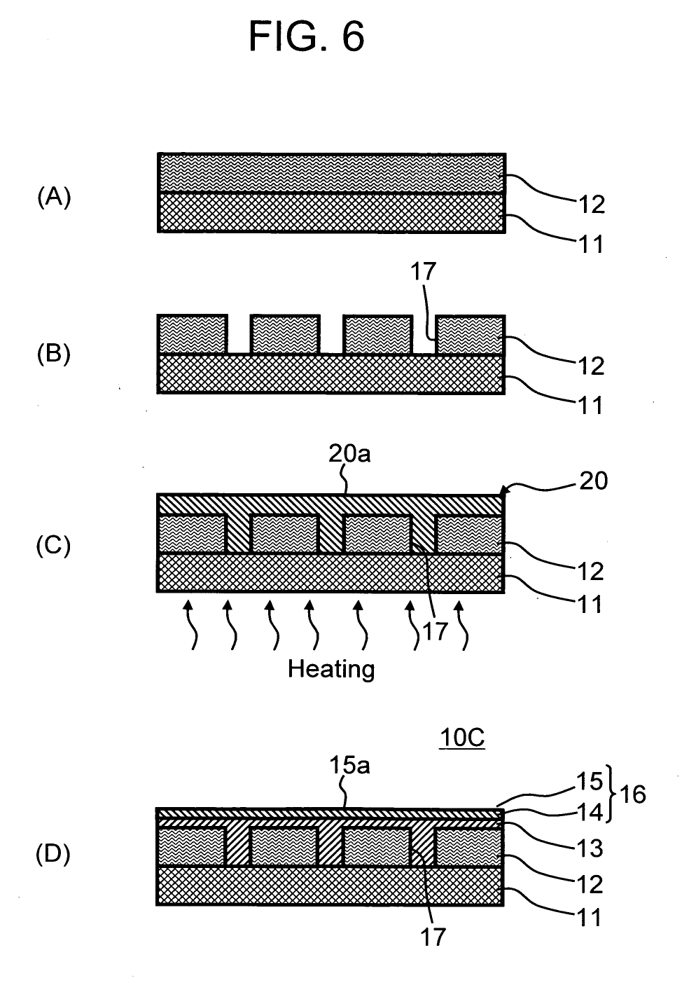

FIG. 5 shows a discrete track medium 10C according to the third embodiment, and FIGS. 6A to 6D show a method for manufacturing the discrete track medium 10C. The discrete track medium 10C and the manufacturing method therefor according to the third embodiment are basically substantially the same as the discrete track medium 10A and the manufacturing method therefor according to the first embodiment described with reference to FIGS. 1 to 2E.

However, although the protective film 13 is formed over the magnetic layer 12 in the first embodiment, the third embodiment is characterized in that the protective film 13 is eliminated. Consequently, the discrete track medium 10C according to the third embodiment has a structure in which a lubricant layer 16 is directly disposed over a soft magnetic layer 11 and a magnetic layer 12 as shown in FIG. 5.

An end group of the lubricant material bonds selectively to a bonding site on the magnetic layer 12. For instance, when the magnetic layer 12 is composed of an Fe-based magnetic material and the lubricant material has a carboxyl end group, the carboxyl end group is bonded to Fe located on the surface of the Fe-based magnetic material. Therefore, the fluidity of the lubricant material decreases gradually from the protective film.

In the method for manufacturing the discrete track medium 10C, the manufacturing steps shown in FIGS. 6A and 6B are the same as those shown in FIGS. 2A and 2B. In the third embodiment, immediately after the grooves 17 are formed in the magnetic layer 12, a lubricant material 20 is arranged as shown in FIG. 6C (arrangement step).

Subsequently, a fixed layer 14 is formed by subjecting the lubricant material 20 to heat treatment from the back side, and the lubricant material 20 is separated into the fixed layer 14 and a fluid layer 15 to form a lubricant layer 16 (curing step), as in the first embodiment. FIG. 6D shows a discrete track medium 10C manufactured by the method according to the third embodiment.

As described above, the protective film 13 is composed of a nonmagnetic material, such as DLC or silicon dioxide, and in order to improve magnetic recording and recording characteristics, the thickness of the protective film 13 is preferably as small as possible within the range in which the magnetic layer 12 can be protected. When a material having corrosion resistance is selected as the material for the magnetic layer 12, it is not always necessary to provide a protective film 13.

Therefore, in the third embodiment, the protective film 13 is eliminated, and the lubricant layer 16 is directly formed over the soft magnetic layer 11 and the magnetic layer 12. By employing such a structure, the step of forming the protective film 13 (film formation step) is not required, and thus the manufacturing process can be simplified. Furthermore, since the protective film 13 is not required, the number of components can be reduced, and the cost of the discrete track medium 10C can be reduced.

A fourth embodiment will now be described.

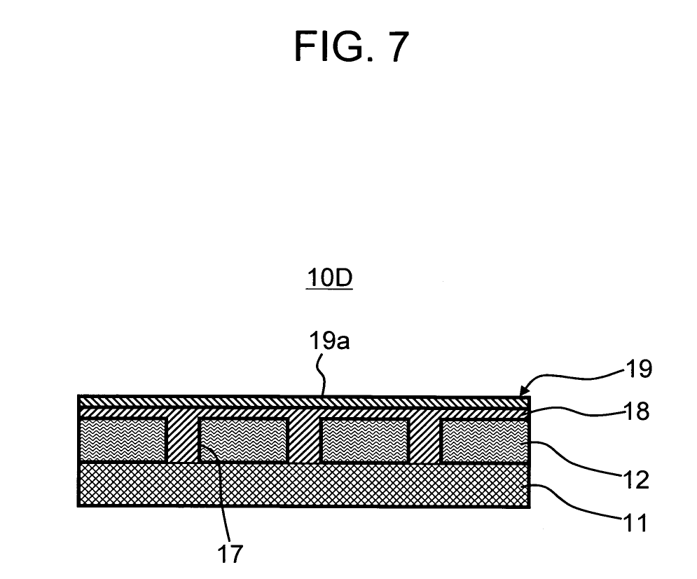

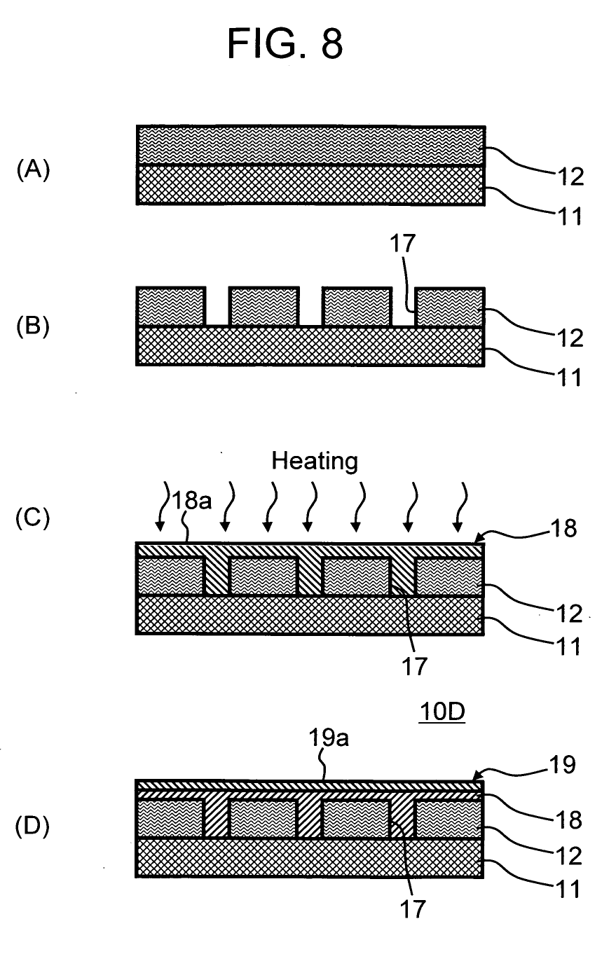

FIG. 7 shows a discrete track medium 10D according to the fourth embodiment, and FIGS. 8A to 8D show a method for manufacturing the discrete track medium 10D. The discrete track medium 10D and the manufacturing method therefor according to the fourth embodiment are basically substantially the same as the discrete track medium 10B and the manufacturing method therefor according to the second embodiment described with reference to FIGS. 3 to 4E.

However, although the protective film 13 is formed over the magnetic layer 12 in the second embodiment, the fourth embodiment is characterized in that the protective film 13 is eliminated. Consequently, the discrete track medium 10D according to the fourth embodiment has a structure in which a fixed lubricant layer 18 and a fluid lubricant layer 19 are directly disposed over a soft magnetic layer 11 and a magnetic layer 12 as shown in FIG. 7.

In the method for manufacturing the discrete track medium 10D, the manufacturing steps shown in FIGS. 8A and 8B are the same as those shown in FIGS. 4A and 4B. In the fourth embodiment, immediately after the grooves 17 are formed in the magnetic layer 12, a lubricant material 20 for forming a fixed lubricant layer 18 is arranged as shown in FIG. 8C (first arrangement step). Subsequently, the lubricant material 20 is cured by heat treatment from the above to form a fixed lubricant layer 18. At that time, a surface 18a of the fixed lubricant layer 18 is a flat surface. Then, a fluid lubricant layer 19 is formed on the fixed lubricant layer 18. Thereby, a discrete track medium 10D shown in FIG. 8D is obtained.

In the discrete track medium 10D and the manufacturing method therefor, the protective film 13 is eliminated as in the third embodiment. Consequently, the step of forming the protective film 13 (film formation step) is not required, and thus the manufacturing process can be simplified. Furthermore, since the protective film 13 is not required, the number of components can be reduced, and the cost of the discrete track medium 10D can be reduced.

A fifth embodiment will now be described.

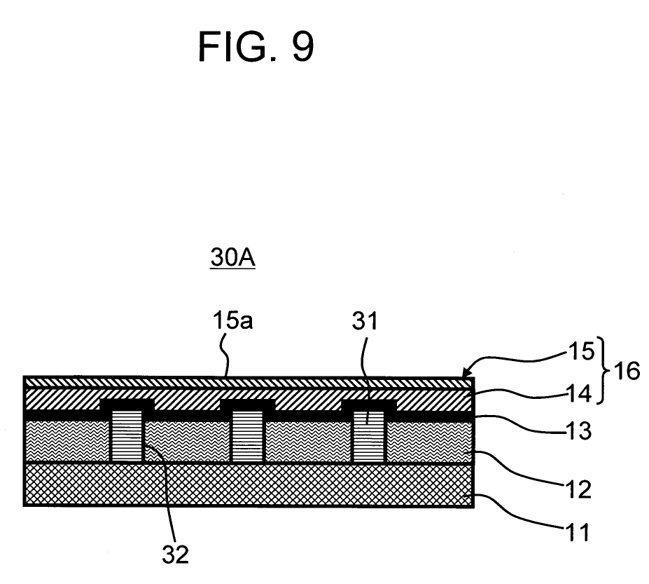

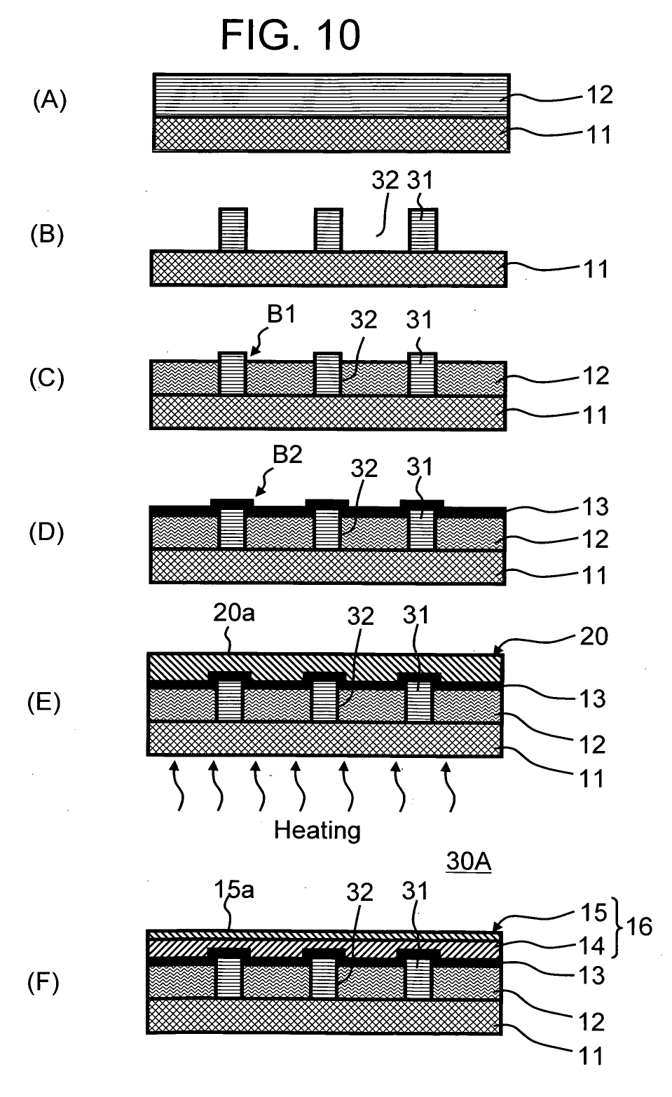

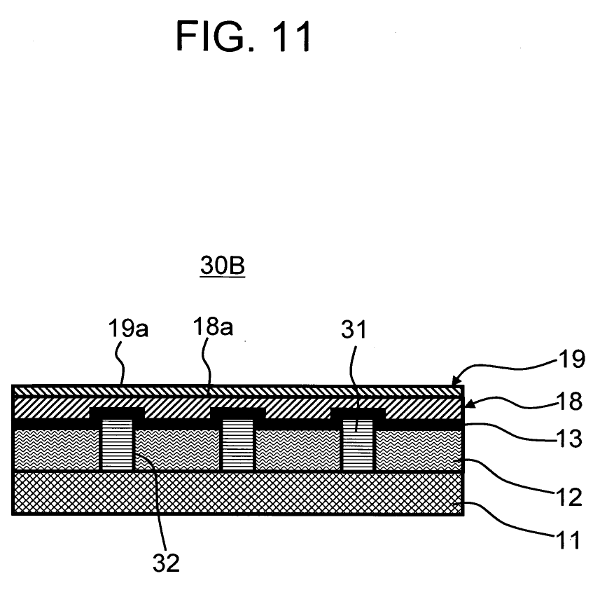

FIG. 9 shows a recording medium 30A according to the fifth embodiment of the present invention, and FIGS. 11A to 10F show a method for manufacturing the recording medium 30A. Note that the recording medium shown as an example in each of FIGS. 9 to 16E is a patterned medium in which interference between adjacent bits is decreased to increase the track recording density. Accordingly, in the description of the embodiments shown in FIGS. 9 to 16E, the recording media are referred to as patterned media 30A to 30D. In FIGS. 9 to 10F, those components corresponding to the components shown in FIGS. 1 to 8D are designated by the same reference numerals, and descriptions thereof are omitted.

The patterned medium 30A shown in FIG. 9 is also, for example, used as a perpendicular magnetic recording medium.

The patterned medium 30A has a structure in which a soft magnetic layer 11, a magnetic layer 12, a protective film 13, a lubricant layer 16, etc. are disposed on a substrate (not shown in the drawing) as in the discrete track medium 10A shown in FIG. 1.

The discrete track medium 10A is characterized in that the grooves 17 are formed in the magnetic layer 12 in order to prevent the occurrence of crosstalk due to an increase in density. In contrast, the patterned medium 30A is characterized in that fine holes (hereinafter referred to as nanoholes 32) are formed in a nonmagnetic layer 31, and the magnetic layer 12 is formed in the nanoholes 32.

As described above, in the patterned medium 30A, since the magnetic layer 12 is formed (grown) in the nanoholes 32, it is difficult to accurately align the upper surface of the nonmagnetic layer 31 with the upper surface of the magnetic layer 12. As a result, stepped portions (irregularities) are formed between the upper surface of the nonmagnetic layer 31 and the upper surface of the magnetic layer 12.

In the fifth embodiment, a protective film 13 that protects the magnetic layer 12 is also disposed over the magnetic layer 12 and the nonmagnetic layer 31. As described above, since the thickness of the protective film 13 is small, the stepped portions are not completely filled with the protective film 13. Consequently, stepped portions (irregularities) resulting from the stepped portions between the upper surface of the nonmagnetic layer 31 and the upper surface of the magnetic layer 12 are also formed in the protective film 13.

Next, the lubricant layer 16 will be described below. The lubricant layer 16 in the fifth embodiment includes a fixed layer 14 and a fluid layer 15 as in the first embodiment. The fixed layer 14 is located on the magnetic layer 12 side, and is a portion cured (which includes a gelated state) by heat treatment or the like from the lower side. In contrast, the fluid layer 15 is not subjected to heat treatment or the like, and thus maintains fluidity. In the fifth embodiment, the fixed layer 14 and the fluid layer 15 are also continuously and integrally formed.

A method for manufacturing the patterned medium 30A having the structure described above will now be described with reference to FIGS. 10A to 10F. In FIGS. 10A to 10F, the same components are designated by the same reference numerals as those in FIG. 9, and descriptions thereof are omitted.

FIG. 10A shows a state in which a soft magnetic layer 11 and a nonmagnetic layer 31 are formed on a substrate (not shown in the drawing). Nanoholes 32 are formed in the nonmagnetic layer 31 as shown in FIG. 10B. The nanoholes 32 are formed, for example, by electron beam lithography or optical lithography.

Subsequently to the formation of the nanoholes 32 in the nonmagnetic layer 31, a magnetic layer 12 is formed inside the nanoholes 32. FIG. 10C shows a state in which the magnetic layer 12 is formed inside the nanoholes 32. At that time, it is difficult to accurately align the upper surface of the nonmagnetic layer 31 with the upper surface of the magnetic layer 12. As a result, stepped portions (irregularities) B1 are formed between the upper surface of the nonmagnetic layer 31 and the upper surface of the magnetic layer 12.

Subsequently to the formation of the magnetic layer 12 in the nanoholes 32, a protective film 13 is formed over the magnetic layer 12 and the nonmagnetic layer 31 (film formation step). The protective film 13 can be formed, for example, by sputtering. FIG. 10D shows a state in which the protective film 13 is formed. Even if the protective film 13 is formed, the stepped portions B1 are not completely filled with the protective film 13, and stepped portions B2 resulting from the stepped portions B1 are also formed in the protective film 13 (as indicated by arrow in FIG. 10D).

Subsequently to the formation of the protective film 13, a lubricant material 20 for forming a lubricant layer 16 is arranged over the protective film 13. FIG. 10E shows a state in which the lubricant material 20 is arranged over the protective film 13. Since the lubricant material 20 having fluidity is arranged, the lubricant material 20 completely covers the stepped portions B2 formed on the protective film 13 (arrangement step).

At that time, no special arrangement step is required to arrange the lubricant material 20 so as to cover the stepped portions B2, and by simply disposing the lubricant material 20 over the protective film 13, the lubricant material 20 having fluidity is arranged so as to cover the stepped portions B2. Furthermore, since the lubricant material 20 has fluidity, even if the lubricant material 20 is arranged over the protective film 13, a surface 20a of the lubricant material 20 is a flat surface without being affected by the shape of the stepped portions on the surface of the protective film 13.

After the completion of the arrangement of the lubricant material 20, the lubricant material 20 is subjected to heating treatment from the lower surface side of the soft magnetic layer 11. In the heat treatment, heat is transferred to the lubricant material 20 through the soft magnetic layer 11, the magnetic layer 12, and the protective film 13 (curing step). The heat treatment causes bonding in a predetermined region of the lubricant material 20 close to the magnetic layer 12, and thereby a fixed layer 14 is formed as well as the above-mentioned.

In contrast, in the upper surface side of the lubricant material 20, heat curing does not occur, and as a result, a fluid layer 15 having fluidity is automatically formed on the upper side of the fixed layer 14. In the fifth embodiment, the fixed layer 14 and the fluid layer 15 are also continuously and integrally formed.

By performing the manufacturing steps described above, a patterned medium 30A shown in FIG. 10F is obtained. In the method for manufacturing the patterned medium 30A according to the fifth embodiment, even if stepped portions are formed between the nonmagnetic layer 31 and the magnetic layer 12, the surface of the fixed layer 14 (lubricant layer 16) is a flat surface as in the first embodiment.

Consequently, polishing treatment, such as CMP, which has been required in the past, is not required, and thus the manufacturing process of the patterned medium 30A can be simplified and the cost can be reduced. Furthermore, since the fluid layer 15 having fluidity is present on the fixed layer 14, lubricity can be maintained. Consequently, it is possible to prevent the recording layer from being degraded or damaged due to heat and impact caused by sliding between the magnetic head 42 and the patterned medium 30A.

A sixth embodiment will now be described.

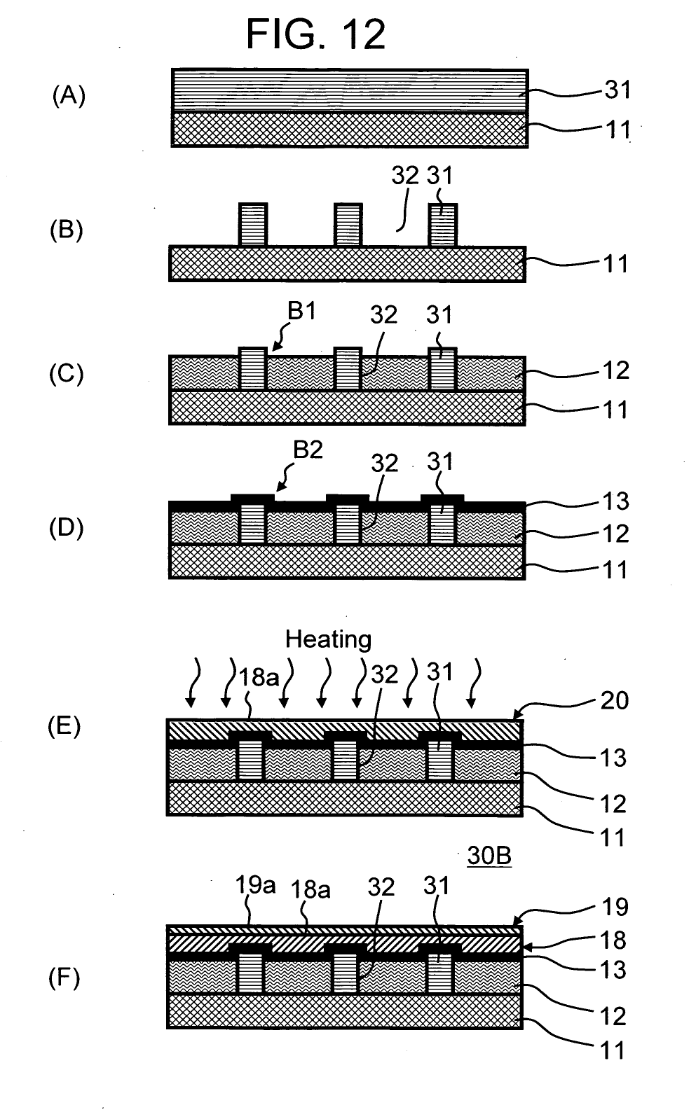

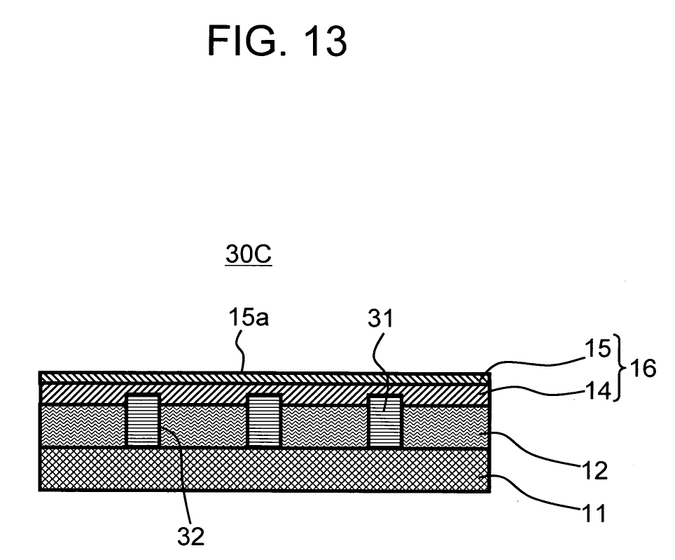

FIG. 11 shows a patterned medium 30B according to the sixth embodiment, and FIGS. 12A to 12F show a method for manufacturing the patterned medium 30B. Note that in FIGS. 13 to 16E which are used for description of the sixth embodiment and onward, the same components are designated by the same reference numerals as those in FIGS. 9 to 10F, and descriptions thereof are omitted.

In the patterned medium 30A according to the fifth embodiment described above, by applying heat to a portion of the lubricant material 20, the lubricant layer 16 has a structure in which the fixed layer 14 and the fluid layer 15 are continuously and integrally formed. In contrast, as shown in FIG. 11, the patterned medium 30B according to the sixth embodiment is characterized in that a lubricant layer has a structure which is formed on a protective film 13 and in which a fixed lubricant layer 18 and a fluid lubricant layer 19 each independently formed are laminated.

The patterned medium 30B is manufactured as shown in FIGS. 12A to 12F. First, as shown in FIG. 12A, a nonmagnetic layer 31 is formed on a soft magnetic layer 11 disposed on a substrate. Then, as shown in FIG. 12B, nanoholes 32 are formed in the nonmagnetic layer 31. Subsequently, as shown in FIG. 12C, a magnetic layer 12 is formed in the nanoholes 32. Then, a protective film 13 is formed by sputtering or the like over the magnetic layer 12 and the nonmagnetic layer 31 as shown FIG. 12D. The manufacturing steps up to this stage are the same as those shown in FIGS. 10A to 10D.

In the sixth embodiment, subsequently, a lubricant material 20 (not shown in the drawing) for forming a fixed lubricant layer 18 is arranged over the protective film 13 (first arrangement step). Since the lubricant material 20 has fluidity, the stepped portions B2 formed in the protective film 13 are also covered with the lubricant material 20. Furthermore, since the lubricant material 20 has fluidity, the surface of the lubricant material 20 is a flat surface even when the lubricant material 20 covers the stepped portions B2.

Subsequently, the lubricant material 20 is cured by heat treatment from the above. Thus, as shown in FIG. 12E, a fixed lubricant layer 18 is formed on the protective film 13 (curing step). As described above, since a surface 20a of the lubricant material 20 before curing is flat, a surface 18a of the fixed lubricant layer 18 which has been heat-cured is also a flat surface.

After the formation of the fixed lubricant layer 18, a lubricant material 20 is further arranged thereon (second arrangement step). This lubricant material 20 is not subjected to heat cure treatment. Consequently, the lubricant material 20 directly serves as a fluid lubricant layer 19. By performing the manufacturing steps described above, a patterned medium 30B shown in FIG. 12F is obtained.

In the method for manufacturing the patterned medium 30B according to the sixth embodiment, polishing treatment, such as CMP, which has been required in the past, is also not required, and thus the manufacturing process can be simplified and the cost can be reduced. Furthermore, since the fluid lubricant layer 19 having fluidity is present on the fixed lubricant layer 18, lubricity can be maintained. Consequently, it is possible to prevent the recording layer from being degraded or damaged due to heat and impact caused by sliding between the magnetic head 42 and the patterned medium 30B.

A seventh embodiment will now be described.

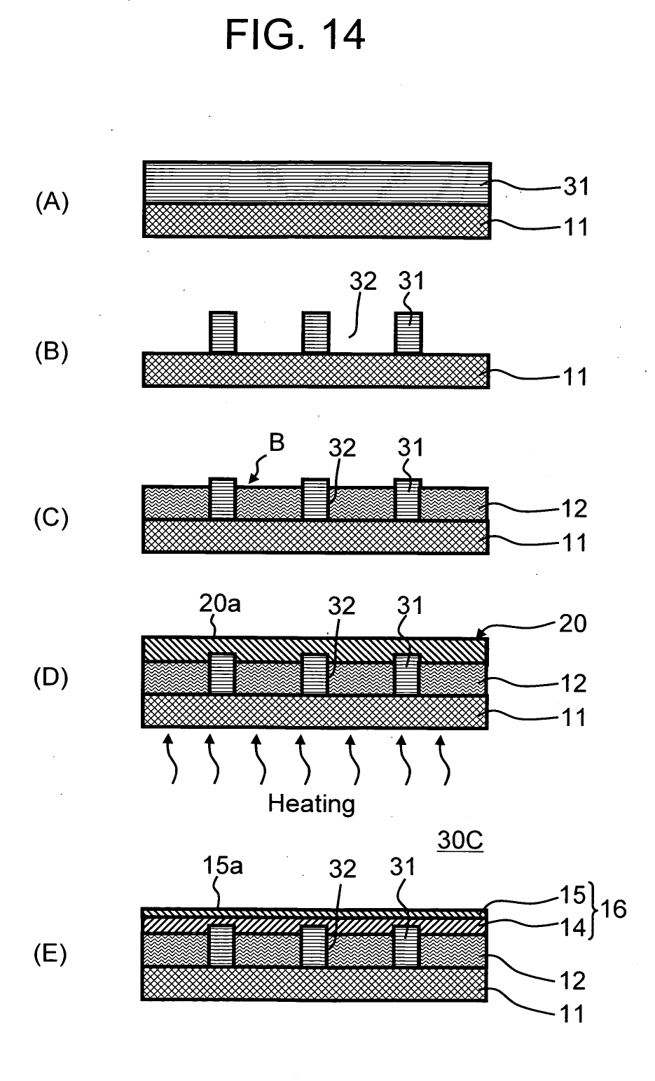

FIG. 13 shows a patterned medium 30C according to the seventh embodiment, and FIGS. 14A to 14E show a method for manufacturing the patterned medium 30C. The patterned medium 30C and the manufacturing method therefor according to the seventh embodiment are basically substantially the same as the patterned medium 30A and the manufacturing method therefor according to the fifth embodiment described with reference to FIGS. 9 to 10F.

However, although the protective film 13 is formed over the magnetic layer 12 in the fifth embodiment, the seventh embodiment is characterized in that the protective film 13 is eliminated. Consequently, the patterned medium 30C according to the seventh embodiment has a structure in which a lubricant layer 16 is directly disposed over a magnetic layer 12 and a nonmagnetic layer 31 as shown in FIG. 13.

In the method for manufacturing the patterned medium 30C, the manufacturing steps shown in FIGS. 14A to 14C are the same as those shown in FIGS. 10A to 10C. In the seventh embodiment, immediately after the magnetic layer 12 is formed in the nanoholes 32, a lubricant material 20 is arranged as shown in FIG. 14D (arrangement step).

Subsequently, a fixed layer 14 is formed by subjecting the lubricant material 20 to heat treatment from the back side, and the lubricant material 20 is separated into the fixed layer 14 and a fluid layer 15 to form a lubricant layer 16 (curing step), as in the fifth embodiment. FIG. 14E shows a patterned medium 30C manufactured by the method according to the seventh embodiment.

In the seventh embodiment, the protective film 13 is eliminated, and the lubricant layer 16 is directly formed over the magnetic layer 12 and the nonmagnetic layer 31. By employing such a structure, the step of forming the protective film 13 (film formation step) is not required, and thus the manufacturing process can be simplified. Furthermore, since the protective film 13 is not required, the number of components can be reduced, and the cost of the patterned medium 30C can be reduced.

An eighth embodiment will now be described.

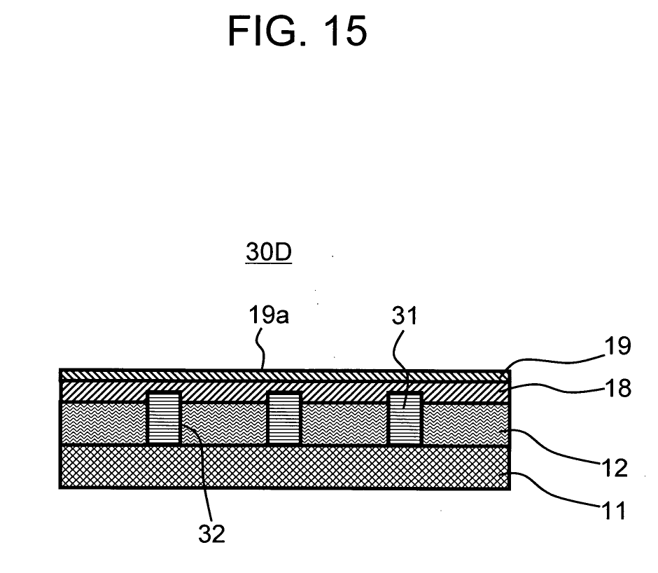

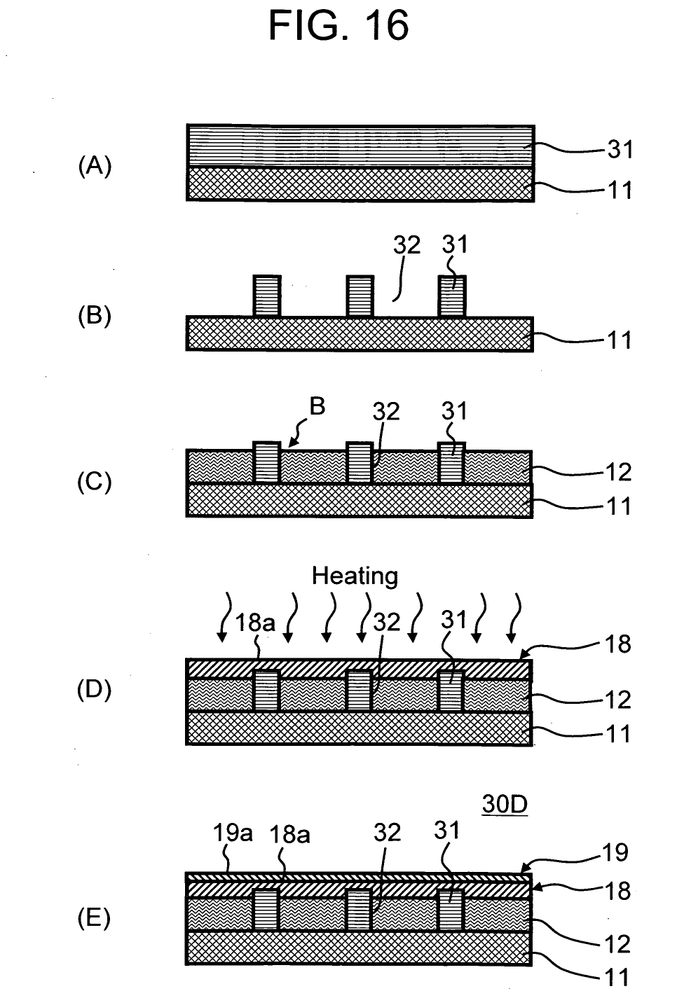

FIG. 15 shows a patterned medium 30D according to the eighth embodiment, and FIGS. 16A to 16E show a method for manufacturing the patterned medium 30D. The patterned medium 30D and the manufacturing method therefor according to the eighth embodiment are basically substantially the same as the patterned medium 30B and the manufacturing method therefor according to the sixth embodiment described with reference to FIGS. 11 to 12F.

However, although the protective film 13 is formed over the magnetic layer 12 in the sixth embodiment, the eighth embodiment is characterized in that the protective film 13 is eliminated. Consequently, the patterned medium 30D according to the eighth embodiment has a structure in which a fixed lubricant layer 18 and a fluid lubricant layer 19 are directly disposed over a magnetic layer 12 and a nonmagnetic layer 31 as shown in FIG. 15.

In the method for manufacturing the patterned medium 30D, the manufacturing steps shown in FIGS. 16A to 16C are the same as those shown in FIGS. 12A to 12C. In the eighth embodiment, immediately after the magnetic layer 12 is formed in the nanoholes 32, a lubricant material 20 for forming a fixed lubricant layer 18 is arranged as shown in FIG. 16D (first arrangement step). Subsequently, the lubricant material 20 is cured by heat treatment from the above to form a fixed lubricant layer 18. At that time, a surface 18a of the fixed lubricant layer 18 is a flat surface. Then, a fluid lubricant layer 19 is formed on the fixed lubricant layer 18. Thereby, a patterned medium 30D shown in FIG. 16E is obtained.

In the patterned medium 30D and the manufacturing method therefor according to the eighth embodiment, the protective film 13 is eliminated as in the seventh embodiment. Consequently, the step of forming the protective film 13 (film formation step) is not required, and thus the manufacturing process can be simplified. Furthermore, since the protective film 13 is not required, the number of components can be reduced, and the cost of the patterned medium 30D can be reduced.

Each of the discrete track media 10A to 10D shown in the first to fourth embodiments and the patterned media 30A to 30D shown in the fifth to eighth embodiments can be applied to a magnetic disk device (recording and reproducing device) 40 shown in FIG. 17. In such a case, since the slidability between the magnetic head 42 and each of the media 10A to 10D and 30A to 30D can be improved and since the magnetic layer 12 can be prevented from being damaged, it is possible to realize a highly reliable magnetic disk device 40.

In the individual embodiments described above, the examples in which heat is used for curing the lubricant material 20 have been shown. The lubricant material 20 may be cured by infrared heat.

Furthermore, in each of the second, fourth, sixth, and eighth embodiments, the fixed lubricant layer 18 and the fluid lubricant layer 19 are composed of the same material. However, the material for the fixed lubricant layer 18 and the material for the fluid lubricant layer 19 are not necessarily the same, and may be selected appropriately according to the environment and conditions of use.

According to the present invention, even when stepped portions exist on the surface of the recording layer, the surface of the lubricant layer is a flat surface. Consequently, polishing treatment, such as CMP, which has been required in the past, is not required, and thus the manufacturing process of the recording medium can be simplified and the cost of the recording medium can be reduced.

Furthermore, since the fluid layer having fluidity is present on the fixed layer, lubricity can be maintained. Consequently, it is possible to prevent the recording layer from being degraded or damaged due to heat and impact caused by sliding between the floating-type magnetic head and the recording medium.

What is claimed is:

1. A recording medium comprising:
a recording layer having a surface uneven, for recording information;
a fixed lubricant layer disposed on the recording layer, the fixed lubricant layer being arranged so as to cover the surface and having a flat surface; and
a fluid lubricant layer laminated on the fixed lubricant layer, the fluid lubricant layer having fluidity.

2. A recording medium comprising:
a recording layer having a surface uneven, for recording information; and
a lubricant layer disposed on the recording layer, the lubricant layer including a fixed layer and a fluid layer integrally laminated to each other, the fixed layer being arranged so as to cover the surface and subjected to cure treatment, the fluid layer having fluidity.

3. The recording medium according to claim 1, further comprising:
a soft magnetic layer disposed under the recording layer composed of a magnetic layer.

4. The recording medium according to claim 2, further comprising:
a soft magnetic layer disposed under the recording layer composed of a magnetic layer.

5. A method for manufacturing a recording medium including a recording layer having a surface uneven, for recording information, the method comprising:
a first arrangement step of arranging a first lubricant having fluidity so as to be arranged on the surface and to have a flat surface;
a curing step of performing cure treatment on the first lubricant to form a fixed lubricant layer; and
a second arrangement step of arranging a second lubricant having fluidity to form a fluid lubricant layer on the fixed lubricant layer.

6. The method according to claim 5, wherein the recording layer is separated by grooves, and the lubricant has fluidity so as to be arranged inside the grooves.

7. The method according to claim 5, the recording medium includes a nonmagnetic layer provided with nanoholes and a recording layer composed of a magnetic layer disposed in the nanoholes, and the first lubricant has fluidity so as to be arranged inside the nanoholes.

8. The method according to claim 5, wherein the cure treatment is performed by heat.

9. The method according to claim 5, wherein the cure treatment is performed by UV irradiation.

10. The method for manufacturing the recording medium according to claim 5, further comprising:
a film formation step of forming a protective film evenly over the entire surface of the recording layer before carrying out the arrangement step.

11. A method for manufacturing a recording medium including a recording layer having a surface uneven, for recording information, the method comprising:
an arrangement step of arranging a lubricant having fluidity so as to be arranged on the surface; and
a curing step of performing cure treatment on the lubricant so that a portion of the lubricant close to the recording layer is cured to form a fixed layer and the remaining portion close to the surface is left as a fluid layer.

12. The method according to claim 11, wherein the recording layer is separated by grooves, and the lubricant has fluidity so as to be arranged inside the grooves.

13. The method according to claim 11, wherein the recording medium including a nonmagnetic layer provided with nanoholes and a recording layer composed of a magnetic layer disposed in the nanoholes, and the lubricant has fluidity so as to be arranged inside the nanoholes.

14. The method according to claim 11, wherein the cure treatment is performed by heat.

15. The method for manufacturing the recording medium according to any one of claim 14, wherein, when the portion of the lubricant close to the recording layer is cured to form the fixed layer, the heat is applied from the back side.

16. The method according to claim 11, wherein the cure treatment is performed by UV irradiation.

17. The method for manufacturing the recording medium according to claim 11, further comprising:
a film formation step of forming a protective film evenly over the entire surface of the recording layer before carrying out the arrangement step.
